(19) United States
(12) Patent Application Publication
(10) Pub. No.: US 2010/0033975 A1
(43) Pub. Date: Feb. 11, 2010

(54) LIGHTING SYSTEM HAVING A FLAT LUMINAIRE AND A FRAME

(76) Inventors: Jürgen Beck, Gerstetten/Heuchlingen (DE); Bert Schlenga, Giengen (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/450,539

(22) PCT Filed: Apr. 9, 2008
(86) PCT No.: PCT/EP2008/054263

§ 371 Date: Sep. 29, 2009

(30) Foreign Application Priority Data
Apr. 16, 2007 (DE) 20 2007 005 456.4

(51) Int. Cl. F21V 3/00

(52) U.S. Cl. 362/311.14; 362/311.01

(57) ABSTRACT

The lighting system according to the invention comprises a flat luminaire (6), the edge region of which is provided with a frame (9), which has a substantially U-shaped profile. The two sides (10, 11) of the U-profile surround the edge region of the flat luminaire (6).

### TECHNICAL FIELD

The invention is based on a lighting system with a frame and a flat lamp arranged therein.

Such lighting systems are used for a wide variety of lighting tasks, in particular also for luminaires in general lighting and for backlighting of liquid crystal displays (LCDs), also referred to as backlight units (BLUs). For backlighting tasks, in particular large-format LCD television sets can be cited which have attracted increasing attention in recent times.

The term “flat lamp” is in this case intended to mean lamps, in particular fluorescent lamps, with a flat geometry which emit white or colored light and, for special applications, also UV light. The flat geometry in this case does not exclude the possibility of, for example, the front side of the flat lamp which is intended for the light emission having a structure, for example being corrugated or ribbed. The lamp vessel of the flat lamp therefore does not necessarily need to be formed from planar glass plates.

In addition to conventional flat lamps with mercury and/or mobile gas fill, the invention is in particular also aimed at flat lamps of the dielectric barrier discharge lamp type. With this lamp type, either the electrodes of one polarity or else all of the electrodes, i.e. the electrodes of both polarities, are separated from the discharge by means of a dielectric layer (dielectrically impeded discharge on one or two sides). Such electrodes are also referred to below as “dielectric electrodes” for short. In addition, it should also be clarified that the dielectric layer does not need to be a layer which is applied to an electrode specifically for this purpose, but can also be formed by a discharge vessel wall, for example, if the typically strip-like or linear electrodes are arranged on the outer side of a discharge vessel wall or within the wall.

Flat lamps of the dielectric barrier discharge lamp type has proven to be particularly efficient flat light sources if they are operated using the pulsed operating method described in U.S. Pat. No. 5,604,410 and are therefore particularly well suited for use in a luminaire or a backlight unit.

### PRIOR ART

Documents EP 1 600 808 A1 has disclosed a lighting system with a flat lamp. Therein, the flat lamp is inserted into a housing with a rear wall and a peripheral side wall. A likewise peripheral frame which has been plugged onto the side wall fixes the flat lamp within the housing.

### DESCRIPTION OF THE INVENTION

The object of the present invention is to provide a further lighting system with a flat lamp in which the flat lamp is mechanically protected in a reliable manner.

This object is achieved by a lighting system with a flat lamp, which is delimited by a peripheral edge and has a front side intended for the light emission and, opposite this, a rear side, a frame, at least sections of which surround at least the edge of the flat lamp, characterized in that the profile of the frame has two limbs which are parallel to one another, are connected to one another via a transverse strut and engage around the edge of the flat lamp in the form of a U.

Particularly advantageous refinements are given in the dependent claims.

The lighting system according to the invention has a flat lamp, whose edge region has been provided with a frame, which has a substantially U-shaped profile. The frame itself comprises one or more identical parts with a U profile owing to the U profile, the individual frame parts can easily be plugged onto the edge of the flat lamp. In this case, the two limbs of the U profile surround the edge region of the flat lamp. The U-shaped profile of the frame or of the individual frame parts is as such preferably designed to be integral. Preferably, the frame is manufactured from polymer, for example silicone, and is preferably in the form of an injection mould. This combines the advantage of simple manufacture with simple handling since each frame part in itself is integral and therefore can easily be plugged onto the corresponding edge region of the flat lamp.

In a preferred embodiment, at least one of the two limbs of the frame has a projection, which narrows the opening of the U profile of the frame. In order to plug on the frame, the limbs of the U profile are bent up slightly. After the plugging-on operation, the limbs in a depression of the edge region of the flat lamp spring back into their original position at a distance from one another. As a result, the frame part plugs securely on the flat lamp. This simplifies the fitting of all of the frame parts and possibly of the flat lamp together with the frame in a further housing. In any case, the edges of the flat lamp are mechanically protected once the frame has been plugged on. A further advantage is the fact that the frame ensures a certain degree of compensation for the lamp tolerances during insertion into a further housing. In addition, the frame makes it possible to adhere to corresponding electrical safety regulations, for luminaires, for example UL 1598 and EN 60598-1, in order to maintain the air gaps and leakage paths in the edge region required therein. The latter is of particular importance when the flat lamp is provided with electrode tracks arranged on the outer side of its base plate, as is explained in the document U.S. Pat. No. 6,762,549 by the Applicant. In this case, dielectric strengths for voltages of possibly several kilovolts, in particular at least 5 kV, are necessary. In addition, when selecting the materials, a high degree of resistance to ageing and UV resistance alongside low levels of out gassing should be strived for. Silicone, for example, has proven to be suitable.

In addition, other materials, such as the following multi-component polymers, for example, are also suitable:

Polyethylene (PE)/polypropylene (PP),

Polymethylmethacrylate (PMMA)/polystyrene (PS),

Cellulose acetate (CA)/acrilonitrile-butadiene-styrene copolymer (ABS) and

Polycarbonates (PC)/ABS.

In a preferred development, the flat lamp together with the plugged-on frame is inserted into a matching trough-like receptacle, i.e. into a base part with peripheral side walls, it being possible for the base part to also have openings. Preferably, the receptacle is covered by a protective shield. This protective shield preferably rests on a supporting section of the frame in order that the bearing forces of the protective shield do not act on the flat lamp which, under certain circumstances, is thin and is therefore sensitive. Suitable materials for the protective shield are, for example, glass, in particular single-pane safety glass, Makrolon or polymer.

In order to keep the individual components of the flat lighting system together, a peripheral over-frame with an angular profile is preferably plugged onto the trough-like receptacle. As a result, the flat lamp including the U profile frame, with or without an additional protective shield, is secured within the receptacle.

### BRIEF DESCRIPTION OF THE DRAWINGS

The invention will be explained in more detail below with reference to an exemplary embodiment. In the figures:

FIG. 1 shows a plan view of an exemplary embodiment of the lighting system according to the invention,

FIG. 2 shows a partial sectional illustration of the lighting system shown in FIG. 1 along the line AA,

FIG. 3 shows a plan view of a variant of the lighting system illustrated in FIG. 1,

FIG. 4 shows a partial sectional illustration of the lighting system shown in FIG. 3 along the line BB.

### PREFERRED EMBODIMENT OF THE INVENTION

In the figures, identical or functionally identical elements have been provided with the same reference symbols.

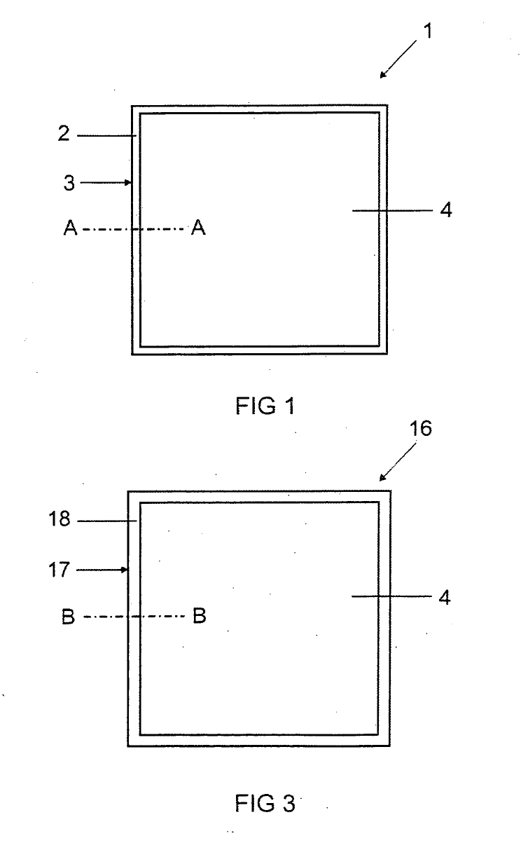

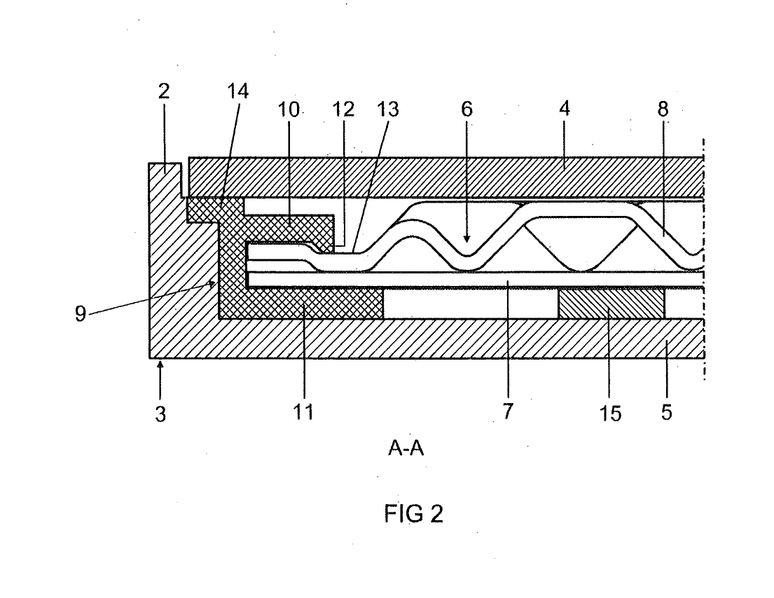

FIG. 1 illustrates, schematically, an exemplary embodiment of the lighting system 1 according to the invention in a plan view from above, i.e. a view onto the front side intended for the light emission. The figure shows the peripheral side wall 2 of a flat, trough-shaped receptacle 3 (see also FIG. 2) made from a thermally conductive material, for example a corresponding polymer. The front side of the lighting system 1 is covered by a protective shield 4 made from Makrolon. A flat lamp, which is not shown in FIG. 1, however, is arranged behind the protective shield 4. In this regard and regarding further details, reference is made below to FIG. 2.

FIG. 2 shows a partial sectional illustration of the lighting system 1 shown in FIG. 1 along the section line AA. The flat lamp 6 is located between the protective shield 4 and the baseplate 5 of the trough-shaped receptacle 3. The flat lamp 6 has a planar bottom plate 7 and a corrugated front plate 8. Strip-like outer electrodes (not illustrated), which are used for operating a dielectrically impeded gas discharge within the flat lamp, are located on the outer side of the bottom plate 7. For further details regarding the flat lamp known per se, reference is made, for example, to the document U.S. Pat. No. 6,762,549 by the Applicant. The edge region of the flat lamp 6 is provided with a frame 9, which is in the form of an elongate U profile injection molded with silicone. Owing to the use of silicone, a high degree of ageing resistance and UV resistance, alongside low levels of out gassing, is achieved. The frame 9 has two limbs 10, 11 of different lengths which are connected in the form of a U and which engage around the edge region of the flat lamp 6. The upper limb 10, which is the most closely adjacent to the front plate 8, has a tab-like protrusion 12, which engages in a matching depression 13 in the edge region of the front plate 8. In order to plug on the frame 9, the two slightly flexible limbs 10, 11 are bent slightly and plugged over the thicker edge region of the flat lamp 6 until the protrusion 12 latches into the depression 13. With the aid of the frame 9, the flat lamp 6 is fitted into the trough-shaped receptacle 3. The frame 9 has in each case a supporting section 14 on the upper limb 10, which supporting section firstly rests on a shoulder of the side wall 2 of the trough-shaped receptacle 3 and secondly acts as a support for the protective shield 4 thereon. The supporting sections 14 arranged along the periphery of the frame 9 ensure that the bearing force of the protective shield 4 does not act on the flat lamp 6. In addition to the frame 9 which encloses and holds the flat lamp 6 at the edge region, a few thin, elastic bearing strips 15 which are made from cellular rubber and are adhesive on two sides (for example “double coated foam tapes” by the company 3M) and with a thickness of at least 2 mm are also provided between the bottom plate 7 of the flat lamp 6 and the baseplate 5 of the trough-shaped receptacle 3. Cellular rubber by the company Polyfoam has also proven suitable for this purpose.

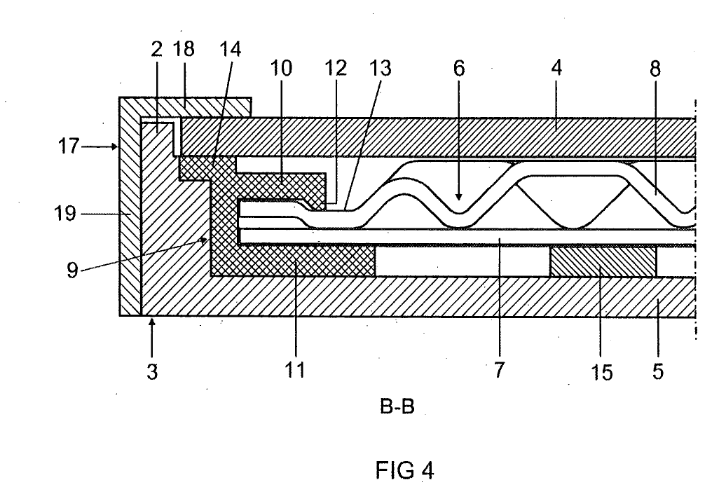

FIGS. 3 and 4 show a variant 16 of the lighting system shown in FIGS. 1 and 2, in a schematic plan view and, respectively, partial sectional view along the line BB. In addition here, a peripheral integral over-frame 17 is plugged in clamping fashion onto the trough-like receptacle 3. The over-frame 17 has an angular profile with the two limbs 18, 19 which are at right angles with respect to one another. The first limb 18 overlaps the outer edge of the protective shield 4. The second limb 19, which is at right angles with respect to said first limb, surrounds the outer side of the peripheral side wall 2 of the trough-shaped receptacle 3. By virtue of the over-frame 17 which is plugged on in clamping fashion, the individual components of the flat lighting system 16 are kept together and finally the flat lamp 6 including the U profile frame 9 is secured within the receptacle 3.

1. A lighting system (1) with
a flat lamp (6), which is delimited by a peripheral edge and has a front side intended for the light emission and, opposite this, a rear side,
a frame (9), at least sections of which surround at least the edge of the flat lamp (6),
characterized in that
the profile of the frame (9) has two limbs (10, 11) which are parallel to one another, are connected to one another via a transverse strut and engage around the edge of the flat lamp (6) in the form of a U.

2. The lighting system as claimed in claim 1, wherein the U-shaped profile of the frame (9) is designed to be integral.

3. The lighting system as claimed in claim 1 or 2, wherein at least one (10) of the two limbs (10, 11) of the frame (9) has a protrusion (12), which narrows the opening of the U-profile of the frame (9) and engages in an associated depression (13) of the edge region of the flat lamp (6).

4. The lighting system as claimed in claim 1 or 2, wherein the frame (9) consists of plastic.

5. The lighting system as claimed in claim 1 or 2, wherein the frame (9) is in the form of an injection mould.

6. The lighting system as claimed in claim 1 or 2, wherein the flat lamp (6) and the frame (9) are inserted into a matching trough-like receptacle (3).

7. The lighting system as claimed in claim 1 or 2, wherein the front side of the flat lamp (6) is covered by a protective shield (4).

8. The lighting system as claimed in claim 7, wherein the protective shield (4) rests on supporting sections (14) of the frame (9).

9. The lighting system as claimed in claim 6, wherein a peripheral over-frame (17) with an angular profile is plugged onto the trough-like receptacle (3) and secures the flat lamp (6) including the U profile frame (9) within the receptacle (3).

10. The lighting system as claimed in claim 1, wherein the flat lamp (6) is designed for operation by means of dielectrically impeded discharge.
